(19) United States
(12) Patent Application Publication
(10) Pub. No.: US 2018/0109978 A1
(43) Pub. Date: Apr. 19, 2018

(54) Managing Packet Switched Services on a Mobile Device

(71) Applicant: QUALCOMM Incorporated, San Diego, CA (US)

(72) Inventors: Suli Zhao, San Diego, CA (US); Uttam Pattanayak, San Diego, CA (US); Yongsheng Shi, San Diego, CA (US); Liping Shen, San Diego, CA (US); Qingxin Chen, San Diego, CA (US)

(21) Appl. No.: 15/296,687

(22) Filed: Oct. 18, 2016

(51) Int. Cl. H04W 36/00; H04B 1/3816; H04W 8/06; H04W 36/18; H04B 7/26; H04L 29/06; H04W 60/06; H04W 60/00; H04W 60/04

(52) U.S. Cl. CPC H04W 36/0022; H04B 1/3816; H04W 8/06; H04W 36/18; H04W 88/06; H04L 65/1016; H04W 60/06; H04W 60/005; H04W 60/04; H04B 7/2631

(57) ABSTRACT

Various methods for managing packet switched (PS) states on a mobile communication device may include performing, on a first subscription on the mobile communication device, a transition from a first radio access technology (RAT) to a second RAT, determining whether at least one application on the mobile communication device is utilizing on-demand PS services on the first subscription, and registering for circuit switched (CS) services but not PS services on the second RAT in response to determining that no applications on the mobile communication device is utilizing on-demand PS services on the first subscription.

### BACKGROUND

Some designs of mobile communication devices—such as smart phones, tablet computers, and laptop computers—contain one or more Subscriber Identity Module (SIM) cards that store subscription information to provide users with access to multiple separate mobile telephony networks. Examples of mobile telephony network technologies, referred to as radio access technologies (RATs), include Third Generation (3G), Fourth Generation (4G), Long Term Evolution (LTE), Time Division Multiple Access (TDMA), Frequency Division Multiple Access (FDMA), Code Division Multiple Access (CDMA), Wideband CDMA (WCDMA), Time Division Synchronous CDMA (TD-SCDMA), Global System for Mobile Communications (GSM), Universal Mobile Telecommunications Systems (UMTS), evolved High Speed Packet Access (HSPA+), Dual-Cell High Speed Packet Access (DC-HSPA), Evolution Data-Optimized (EV-DO), Enhanced Data rates for GSM Evolution (EDGE), and single carrier Radio Transmission Technologies (1xRTT).

A mobile communication device that includes multiple SIMs and connects to two or more separate mobile telephony networks using a shared radio frequency (RF) resource/radio may be termed a multi-SIM multi-standby (MSMS) communication device. One example of an MSMS communication device is a dual-SIM dual-standby (DSDS) communication device, which includes two SIM cards supporting two subscriptions sharing one RF resource. In DSDS communication devices, the separate subscriptions share the one RF resource to communicate with two separate mobile telephony networks on behalf of their respective subscriptions. When one RAT is using the RF resource, the other RAT is in stand-by mode and is not able to communicate using the RF resource. In a DSDS communication device, the two subscriptions may be associated with mobile telephony networks that employ different RATs.

### SUMMARY

Various examples of methods for managing packet switched (PS) states on a mobile communication device may include performing, on a first subscription on the mobile communication device, a transition from a first radio access technology (RAT) to a second RAT, determining whether at least one application on the mobile communication device is utilizing on-demand PS services on the first subscription, and registering for circuit switched (CS) services but not PS services on the second RAT in response to determining that no applications on the mobile communication device is utilizing on-demand PS services on the first subscription.

In some examples, registering for CS services on the second RAT may include performing a location area update on the first subscription. Some example methods may further include registering for PS services and CS services on the second RAT in response to determining that at least one application on the mobile communication device is utilizing on-demand PS services on the first subscription. In some examples, registering for PS and CS services on the second RAT may include performing a routing area update on the first subscription. Some example methods may further include determining whether all applications cease utilizing PS services, and de-registering from on-demand PS services on the second RAT in response to determining that all applications cease utilizing PS services.

Some example methods may further include determining whether an application initiates use of PS services after registering for CS services on the second RAT, and registering for PS services on the second RAT in response to determining that an application initiates use of PS services after registering for CS services on the second RAT. Such example methods may further include determining whether the application ceases utilizing PS services, and de-registering from PS services on the second RAT in response to determining that the application ceases utilizing PS services.

Some example methods may further include retaining a registration state of the first RAT, in which the registration state of the first RAT comprises a packet data network context and an evolved packet system mobility management registered state of the first RAT. Such example methods may further include performing a transition from the second RAT to the first RAT, and registering for PS and CS services on the first RAT using the retained registration state of the first RAT. Such example methods may further include determining whether PS de-registration has been performed on the second RAT, and performing a full attach procedure on the first RAT in response to determining that PS de-registration has been performed on the second RAT, in which registering for PS and CS services on the first RAT using the retained registration state of the first RAT is performed in response to determining that PS de-registration has not been performed on the second RAT.

In some examples, the first RAT may be a long term evolution (LTE) RAT. In some examples, the second RAT may be a Wideband Code Division Multiple Access (WCDMA) RAT or a Global System for Mobile Communications (GSM) RAT. In some examples, the first subscription may be a non-designated data subscription. In some examples, the on-demand PS services may include a non-Internet Protocol (IP) Multimedia System (IMS) packet data network (PDN) service.

Further examples include a mobile communication device including a memory and a processor configured to perform operations of the methods summarized above. Further examples include a non-transitory processor-readable storage medium having stored thereon processor-executable software instructions configured to cause a processor of a mobile communication device to perform operations of the methods summarized above. Further examples include a mobile communication device that includes means for performing functions of the operations of the methods summarized above.

### BRIEF DESCRIPTION OF THE DRAWINGS

The accompanying drawings, which are incorporated herein and constitute part of this specification, illustrate examples, and together with the general description and the detailed description given herein, serve to explain the features of the disclosed systems and methods.

FIG. 1 is a communication system block diagram of mobile telephony networks suitable for use with various examples.

FIG. 2 is a component block diagram of a multi-SIM mobile communication device according to various examples.

FIG. 3 is a call flow diagram illustrating conventional management of packet switched (PS) states on a mobile communication device.

FIGS. 4A and 4B are call flow diagrams illustrating the management of PS states on a mobile communication device according to various examples.

FIG. 5 is a process flow diagram illustrating a method for managing PS states on a mobile communication device according to various examples.

FIG. 6 is a component block diagram of a mobile communication device suitable for implementing some example methods.

### DETAILED DESCRIPTION

Various examples will be described in detail with reference to the accompanying drawings. Wherever possible, the same reference numbers will be used throughout the drawings to refer to the same or like parts. References made to particular examples and implementations are for illustrative purposes, and are not intended to limit the scope of the written description or the claims.

As used herein, the term “mobile communication device,” “multi-SIM mobile communication device,” or “multi-SIM device” refers to any one or all of cellular telephones, smart phones, personal or mobile multi-media players, personal data assistants, laptop computers, tablet computers, smart books, smart watches, palm-top computers, wireless electronic mail receivers, multimedia Internet-enabled cellular telephones, wireless gaming controllers, and similar personal electronic devices that includes one or more SIM cards, a programmable processor, memory, and circuitry for connecting to at least two mobile communication network with one or more shared RF resources. Various examples may be useful in mobile communication devices, such as smart phones, and so such devices are referred to in the descriptions of various examples. However, the examples may be useful in any electronic devices that may individually maintain a plurality of RATs supporting one or more subscriptions that utilize at least one shared RF chain, which may include one or more of antennae, radios, transceivers, etc.

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a mobile communication device on a network and enable a communication service with the network. Because the information stored in a SIM enables the mobile communication device to establish a communication link for a particular communication service with a particular network, the term “subscription” is used herein as a shorthand reference to refer to the communication service associated with and enabled by the information stored in a particular SIM as the SIM and the communication network, as well as the services and subscriptions supported by that network, correlate to one another.

In the following descriptions of various examples, references are made to a first subscription and a second subscription, and to a first RAT and a second RAT. The references to the first and second subscriptions and RATs are arbitrary and are used merely for the purposes of describing the examples. The device processor may assign any indicator, name or other designation to differentiate the subscriptions and RATs on the mobile communication device.

MSMS mobile communication devices may include one or more SIM cards that support two or more subscriptions. Each subscription may connect to its respective mobile telephony networks using one or more RATs. For example, a DSDS mobile communication device may include two subscriptions that are both able connect to its respective network through a LTE or another newer generation RAT (e.g., 4G, 5G). One subscription may be the designated data subscription (DDS), while the other subscription is a non-DDS subscription. The non-DDS subscription may support Internet protocol (IP) multimedia system (IMS) services on the LTE RAT and certain packet switched (PS) services over LTE or general packet radio service (GPRS) RATs such as GSM or WCDMA in addition to circuit switched (CS) services.

The non-DDS subscription may initially connect to its respective network through a LTE RAT or another newer generation RAT to receive both PS and CS services. However, the non-DDS subscription may perform an inter-RAT transition to another RAT. For example, the non-DDS subscription may perform a RAT reselection from a LTE RAT to a GSM or WCDMA RAT. In another example, the network of the non-DDS subscription may perform a RAT redirection to redirect the non-DDS subscription from the LTE RAT to a GSM or WCDMA RAT.

While connected to the network through a legacy RAT, such as GSM or WCDMA or another 2G or 3G RAT, the non-DDS subscription may need to provide PS services in certain circumstances, for example when multimedia messaging services (MMS) or other applications that utilize PS services are active. Applications may not utilize PS services very frequently, and therefore PS services may not be needed most of the time while the non-DDS subscription is connected to a GSM or WCDMA RAT. For example, the PS services may be provided over on-demand packet data networks (PDNs), or non-IMS PDNs. However, the amount of signaling that is used to maintain PS services through legacy RATs such as GSM and WCDMA is relatively high compared to the signaling used to maintain CS services. Increased signaling may increase the power consumption of the mobile communication device.

To overcome this problem, various examples include methods implemented with a processor of a mobile communication device (e.g., a multi-SIM mobile communication device) for managing PS states when a subscription undergoes inter-RAT transitions. In an MSMS mobile communication device supporting a first subscription and a second subscription, the second subscription may be the DDS subscription and the first subscription may be the non-DDS subscription. The first subscription may be connected to its respective network through a first RAT (e.g., a LTE RAT or another newer generation RAT) and may be registered to provide both PS and CS services. In this configuration, the first subscription may transition from the first RAT to a second RAT (e.g., GSM or WCDMA or another 2G or 3G RAT). The transition may be a RAT reselection initiated by the mobile communication device, or a RAT redirection initiated by the network. When the inter-RAT transition occurs, the device processor may determine whether any applications are utilizing PS services on the first subscription. If no applications are utilizing PS services, then the first subscription may register for CS services on the second RAT but not PS services. This decreases the amount of signaling that occurs while connected through the second RAT. If there is at least one application that utilizes PS services, then the first subscription may register for both PS and CS services on the second RAT.

While connected through the second RAT, the device processor may determine whether any applications initiates use of PS services, or are continuing to use PS services if they were active when the transition occurred. If an application initiates use of PS services, the first subscription may register for PS services through the second RAT as long as the application utilizes PS services. Once all applications cease use of PS services, the first subscription may de-register from PS services through the second RAT. In this manner, signaling for PS services on the non-DDS subscription is dynamically enabled depending on demand from applications that may utilize PS services infrequently. This may reduce power consumption on the mobile communication device.

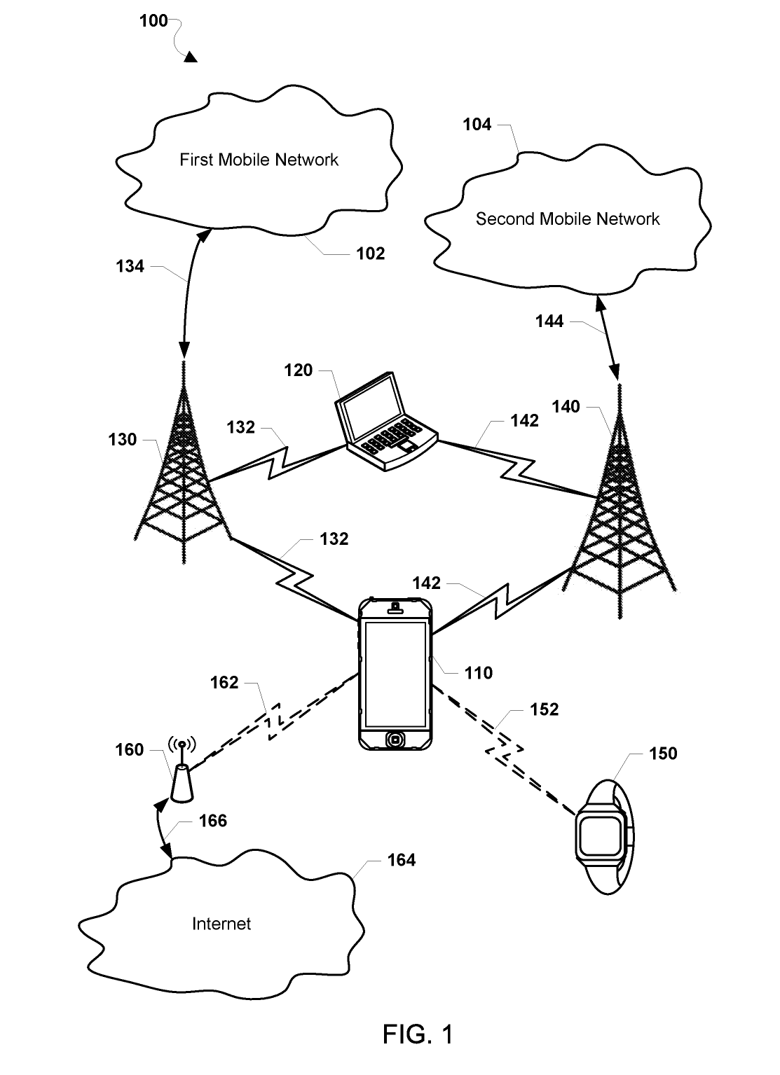

Various examples may be implemented within a variety of communication systems 100, such as at least two mobile telephony networks, an example of which is illustrated in FIG. 1. A first mobile network 102 and a second mobile network 104 typically each include a plurality of cellular base stations (e.g., a first base station 130 and a second base station 140). A first mobile communication device 110 may be in communication with the first mobile network 102 through a cellular connection 132 to the first base station 130. The first mobile communication device 110 may also be in communication with the second mobile network 104 through a cellular connection 142 to the second base station 140. The first base station 130 may be in communication with the first mobile network 102 over a wired connection 134. The second base station 140 may be in communication with the second mobile network 104 over a wired connection 144.

A second mobile communication device 120 may similarly communicate with the first mobile network 102 through the cellular connection 132 to the first base station 130. The second mobile communication device 120 may also communicate with the second mobile network 104 through the cellular connection 142 to the second base station 140. The cellular connections 132 and 142 may be made through two-way wireless communication links, such as Third Generation (3G), Fourth Generation (4G), Long Term Evolution (LTE), Time Division Multiple Access (TDMA), Code Division Multiple Access (CDMA), Wideband CDMA (WCDMA), Global System for Mobile Communications (GSM), Universal Mobile Telecommunications Systems (UMTS), and other mobile telephony communication technologies.

While the mobile communication devices 110, 120 are shown connected to the first mobile network 102 and, optionally, to the second mobile network 104, in some examples (not shown), the mobile communication devices 110, 120 may include two or more RATs to two or more mobile networks and may connect to those RATs in a manner similar to those described herein.

In some examples, the first mobile communication device 110 may optionally establish a wireless connection 152 with a peripheral device 150 used in connection with the first mobile communication device 110. For example, the first mobile communication device 110 may communicate over a Bluetooth® link with a Bluetooth-enabled personal computing device (e.g., a “smart watch”). In some examples, the first mobile communication device 110 may optionally establish a wireless connection 162 with a wireless access point 160, such as over a Wi-Fi connection. The wireless access point 160 may be configured to connect to the Internet 164 or another network over a wired connection 166.

While not illustrated, the second mobile communication device 120 may similarly be configured to connect with the peripheral device 150 and/or the wireless access point 160 over wireless links.

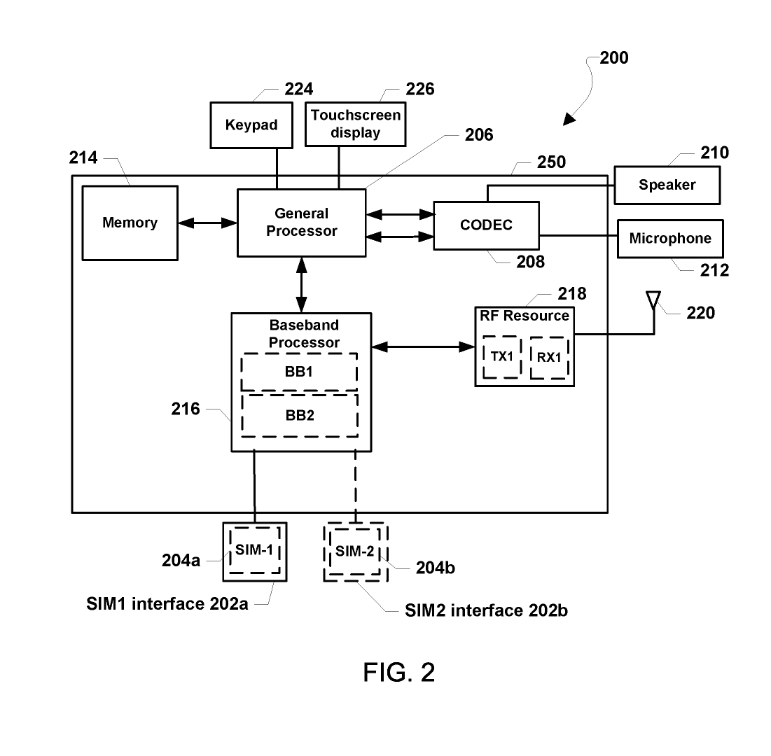

FIG. 2 is a functional block diagram of a multi-SIM mobile communication device 200 suitable for implementing various examples. With reference to FIGS. 1-2, the multi-SIM mobile communication device 200 may be similar to one or more of the mobile communication devices 110, 120 as described. The multi-SIM mobile communication device 200 may include a first SIM interface 202a, which may receive a first identity module SIM-1 204a that is associated with a first subscription. The multi-SIM mobile communication device 200 may also optionally include a second SIM interface 202b, which may receive an optional second identity module SIM-2 204b that is associated with a second subscription.

A SIM in various examples may be a Universal Integrated Circuit Card (UICC) that is configured with SIM and/or Universal SIM applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. A SIM card may have a central processing unit (CPU), read only memory (ROM), random access memory (RAM), electrically erasable programmable read only memory (EEPROM) and input/out (I/O) circuits.

A SIM used in various examples may contain user account information, an international mobile subscriber identity (IMSI), a set of SIM application toolkit (SAT) commands, and storage space for phone book contacts. A SIM card may further store home identifiers (e.g., a System Identification Number (SID)/Network Identification Number (NID) pair, a Home Public Land Mobile Number (HPLMN) code, etc.) to indicate the SIM card network operator provider. An Integrated Circuit Card Identity (ICCID) SIM serial number may be printed on the SIM card for identification. However, a SIM may be implemented within a portion of memory of the multi-SIM mobile communication device 200 (e.g., in a memory 214), and thus need not be a separate or removable circuit, chip or card.

The multi-SIM mobile communication device 200 may include at least one controller, such as a general processor 206, which may be coupled to a coder/decoder (CODEC) 208. The CODEC 208 may in turn be coupled to a speaker 210 and a microphone 212. The general processor 206 may also be coupled to the memory 214. The memory 214 may be a non-transitory computer-readable storage medium that stores processor-executable instructions. For example, the instructions may include routing communication data relating to the first or second subscription though a corresponding baseband-RF resource chain. The memory 214 may store a high level operating system, as well as user application software and executable instructions.

The general processor 206 and the memory 214 may each be coupled to at least one baseband modem processor 216. Each SIM and/or RAT in the multi-SIM mobile communication device 200 (e.g., the SIM-1 204a and/or the SIM-2 204b) may be associated with a baseband-RF resource chain. A baseband-RF resource chain may include the baseband modem processor 216, which may perform baseband/modem functions for communications with/controlling a RAT, and may include one or more amplifiers and radios, referred to generally herein as RF resources (e.g., RF resource 218). In some examples, baseband-RF resource chains may share the baseband modem processor 216 (i.e., a single device that performs baseband/modem functions for all RATs on the multi-SIM mobile communication device 200). In other examples, each baseband-RF resource chain may include physically or logically separate baseband processors (e.g., BB1, BB2).

The RF resource 218 may be a transceiver that performs transmit/receive functions for each of the SIMs/RATs on the multi-SIM mobile communication device 200. The RF resource 218 may include separate transmit and receive circuitry, or may include a transceiver that combines transmitter and receiver functions. In some examples, the RF resource 218 may include multiple receive circuitries. The RF resource 218 may be coupled to a wireless antenna (e.g., a wireless antenna 220). The RF resource 218 may also be coupled to the baseband modem processor 216.

In some examples, the general processor 206, the memory 214, the baseband processor(s) 216, and the RF resource 218 may be included in the multi-SIM mobile communication device 200 as a system-on-chip 250. In some examples, the first and second SIMs 204a, 204b and the corresponding interfaces 202a, 202b may be external to the system-on-chip 250.

Various input and output devices may be coupled to components on the system-on-chip 250, such as interfaces or controllers. Example user input components suitable for use in the multi-SIM mobile communication device 200 may include, but are not limited to, a keypad 224, a touchscreen display 226, and the microphone 212. In some examples, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive selection of a contact from a contact list or receive a telephone number. As another example, the request to initiate the outgoing call may be in the form of a voice command received via the microphone 212. Interfaces may be provided between the various software modules and functions in the multi-SIM mobile communication device 200 to enable communication between them, as is known in the art.

Functioning together, the two SIMs 204a, 204b, the baseband processor BB1, BB2, the RF resource 218, and the wireless antenna 220 may constitute two or more radio access technologies (RATs). For example, the multi-SIM mobile communication device 200 may be a LTE communication device that includes a SIM, baseband processor, and RF resource configured to support two different RATs, such as LTE, WCDMA, and GSM. More RATs may be supported on the multi-SIM mobile communication device 200 by adding more SIM cards, SIM interfaces, RF resources, and antennae for connecting to additional mobile networks.

In some examples (not shown), the multi-SIM mobile communication device 200 may include, among other things, additional SIM cards, SIM interfaces, a plurality of RF resources associated with the additional SIM cards, and additional antennae for supporting subscriptions communications with additional mobile networks.

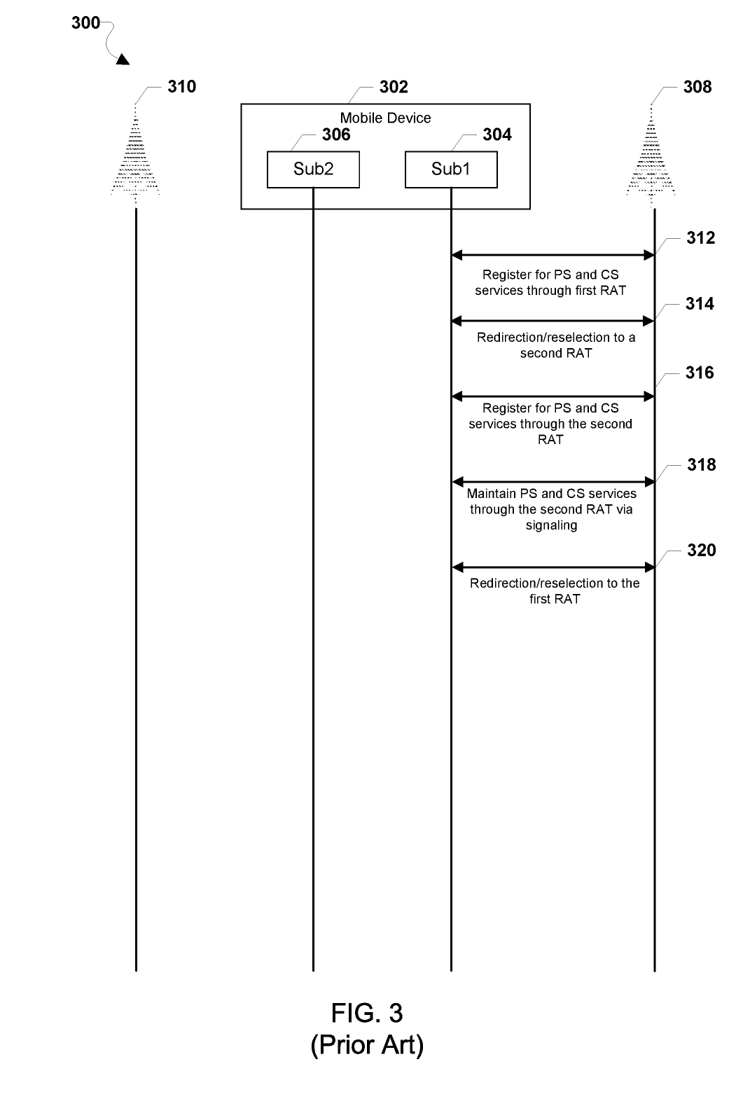

FIG. 3 includes a call flow diagram 300 illustrating the management of PS states on a mobile communication device 302 according to conventional methods. The mobile communication device 302 may be supporting a first subscription 304 and a second subscription 306. The second subscription 306 may be the DDS subscription and the first subscription 304 may be the non-DDS subscription. The first subscription 304 may communicate with a first network 308 through two or more RATs. A first RAT may be an LTE RAT or another newer generation RAT (e.g., 4G or 5G) while a second RAT may be a GSM or WCDMA RAT or another legacy RAT (e.g., 2G or 3G). The second subscription 306 may communicate with a second network 310 through one or more RATs (e.g., LTE).

The first subscription 304 may register for both PS and CS services with the first network 308 through the first RAT in operation 312. One or more applications on the mobile communication device 302 may utilize PS services on the first subscription 304 to receive and transmit information. For example, an application may connect to a non-IMS PDN on the first subscription 304. However, such applications may not utilize PS services frequently.

The first subscription 304 and the first network 308 may perform a transition to a second RAT in operation 314. The inter-RAT transition may be caused, for example, by a RAT reselection initiated by the mobile communication device 302 or a RAT redirection initiated by the first network 308. Inter-RAT transitions may occur, for example, when attempting to acquire a stronger signal from the first network 308 or during handovers to neighboring cells.

The first subscription 304 may register for both PS and CS services with the first network 308 through the second RAT in operation 316. For example, the first subscription 304 may perform a routing area update (RAU) with the first network 308 in order to notify the first network 308 of the current routing area of the mobile communication device 302 to receive PS services.

The first subscription 304 and the first network 308 may then maintain PS and CS services through the second RAT via signaling in operation 318. Maintaining such signaling may consume a lot of power on the mobile communication device 302. However, applications on the mobile communication device 302 may not utilize PS services very frequently. For example, MIMS applications or applications that connect to a non-IMS PDN may utilize the PS services in a burst nature, with long time gaps between the bursts. This may lead to unnecessary power consumption because PS service signaling over the second RAT does not have to be maintained all of the time.

At some time later, the first subscription 304 may transition back from the second RAT to the first RAT and resume both PS and CS service through the first RAT in operation 320. Thus, even though both PS and CS services may be maintained through inter-RAT transitions, PS services may not be utilized frequently while significant signaling overhead (and associated power consumption) is used to maintain PS service signaling during inter-RAT transitions.

To overcome these limitations of conventional methods, various examples disclosed herein enable a subscription to dynamically register or de-register from PS services depending on the current demand. If no applications are utilizing on-demand PS services when an inter-RAT transition occurs from a first RAT to a second RAT, then the subscription registers for CS services but not PS services on the second RAT. If at a later time an application supported by the subscription starts using on-demand PS services, the subscription may register for PS services through the second RAT until the application ceases use of PS services. In this manner, the signaling overhead for PS services is reduced because the signaling is limited to when an application actively uses PS services.

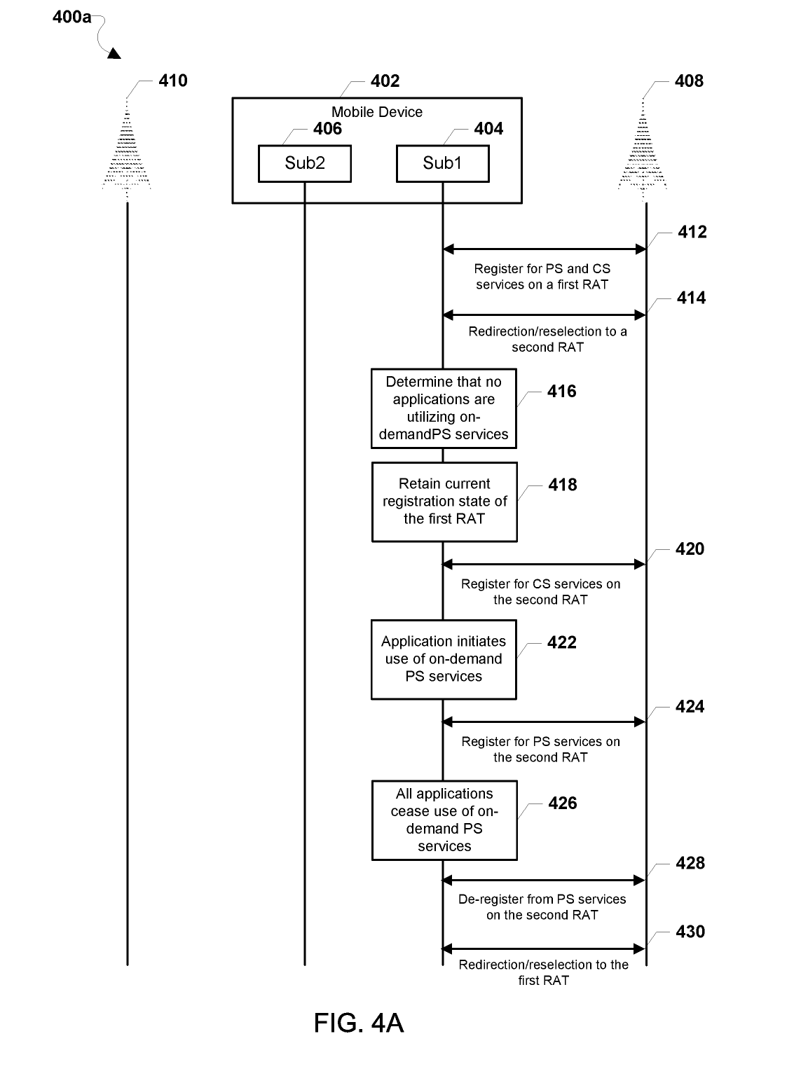

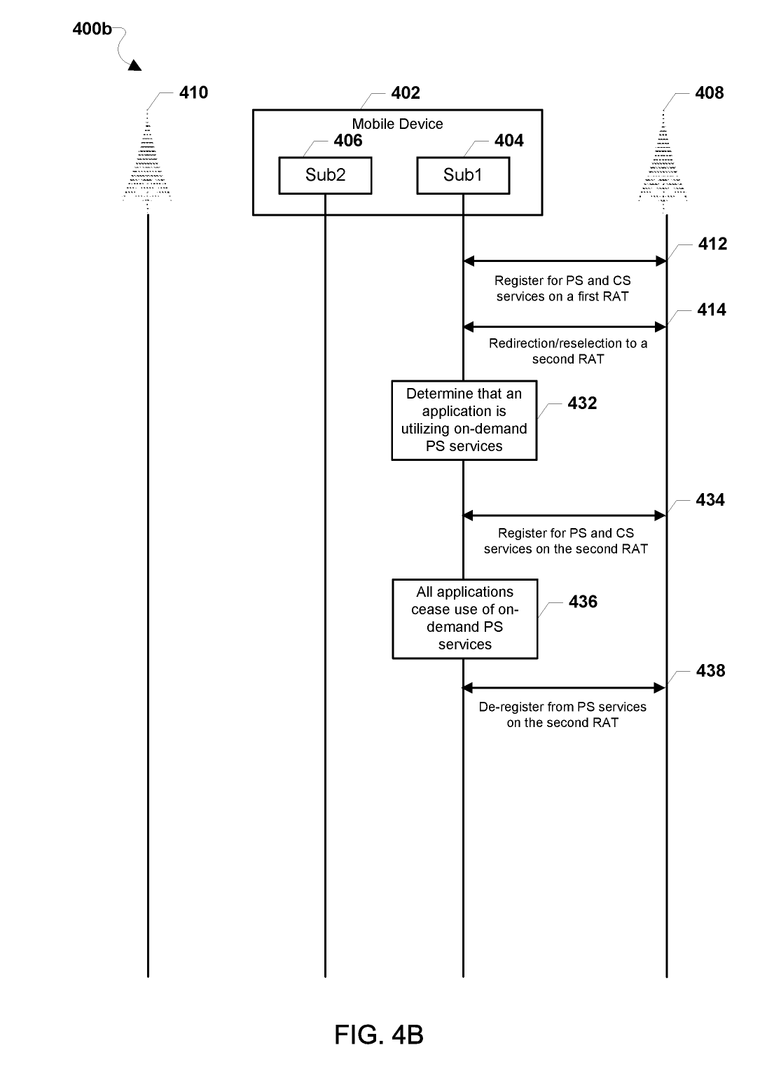

FIGS. 4A-4B include call flow diagrams 400a and 400b illustrating the management of PS states on a mobile communication device 402 according to various examples. The mobile communication device 402 may include a first subscription 404 and a second subscription 406. The second subscription 406 may be the DDS subscription and the first subscription 404 may be the non-DDS subscription. The first subscription 404 may communicate with a first network 408 through two or more RATs. A first RAT may be a LTE RAT or another newer generation RAT (e.g., 4G, 5G) while a second RAT may be a GSM or WCDMA RAT or another legacy RAT (e.g., 2G, 3G). The second subscription 406 may communicate with a second network 410 through one or more RATs (e.g., LTE).

With reference to FIG. 4A, the first subscription 404 may register for both PS and CS services with the first network 408 through the first RAT in operation 412. One or more applications on the mobile communication device 402 may utilize on-demand PS services on the first subscription 404 to receive and transmit information. For example, an application may connect to a non-IMS PDN on the first subscription 404.

The first subscription 404 and the first network 408 may perform a transition to a second RAT in operation 414. The transition may be caused, for example, by a RAT reselection initiated by the mobile communication device 402 or a RAT redirection initiated by the first network 408. Inter-RAT transitions may occur, for example, when attempting to acquire a stronger signal from the first network 408 or during handovers to neighboring cells.

When an inter-RAT transition occurs, the first subscription 404 may determine whether there are any applications that are currently utilizing on-demand PS services on the first subscription 404. For example, the first subscription 404 may check whether there are any applications connecting to a non-IMS PDN on the first subscription 404. In response to determining that there are no applications that are currently utilizing on-demand PS services in operation 416, the first subscription 404 may retain the registration state of the first RAT in operation 418. For example, the first subscription 404 may cache the PDN context and the evolved packet system (EPS) mobility management (EMM) registered state of the first RAT in local memory. This information may be used to quickly resume PS services on the first subscription 404 if the first subscription 404 performs an inter-RAT transition back to the first RAT.

When no applications are utilizing on-demand PS services on the first subscription 404, the first subscription 404 may register for CS services (but not PS services) with the first network 408 through the second RAT in operation 420. For example, the first subscription 404 may perform a location area update (LAU) with the first network 408 through the second RAT. The LAU may notify the first network 408 of the location of the mobile communication device 402 in order to receive CS services. However, the first subscription 404 may not perform a routing area update (RAU), which would notify the first network 408 of the location of the mobile communication device 402 in order to receive PS services in addition to CS services. In this manner, the signaling between the first subscription 404 and the first network 408 through the second RAT is limited to CS service signaling.

At a later time, an application may initiate use of on-demand PS services on the first subscription 404 in operation 422. For example, an application may connect to a non-IMS PDN. When this occurs, the first subscription 404 may register for PS services with the first network 408 through the second RAT in operation 424. For example, the first subscription 404 may perform a packet data protocol (PDP) establishment procedure with the first network 408.

At a later time, all applications (in particular the application that initiated the PS service in operation 422) may cease use of on-demand PS services through the second RAT in operation 426, for example by releasing the PDP. In response, the first subscription 404 may de-register from PS services with the first network 408 through the second RAT in operation 428.

The first subscription 404 and the first network 408 may perform a transition back to the first RAT in operation 430. For example, the inter-RAT transition may be a RAT reselection or a RAT redirection. After the inter-RAT transition occurs, the first subscription 404 may load the cached registration state (e.g., the PDN context and EMM registration state information) from memory and perform a tracking area update (TAU) with the first network 408 to receive PS and CS services. Reloading the registration state information and performing a TAU may be quicker than performing a full attach procedure with the first network 408 through the first RAT.

With reference to FIG. 4B, when the inter-RAT transition occurs in operation 414, the first subscription 404 may determine that at least one application is currently utilizing on-demand PS services on the first subscription 404 in operation 432. For example, there may be at least one application connecting to a non-IMS PDN on the first subscription 404. In response, the first subscription 404 may register for both PS and CS services with the first network 408 through the second RAT in operation 434. For example, the first subscription 404 may perform a RAU with the first network 408 through the second RAT. The RAU may notify the first network 408 of the location of the mobile communication device 402 in order to receive PS and CS services.

At a later time, all applications may cease use of on-demand PS services through the second RAT in operation 436, for example by releasing the PDP. In response, the first subscription 404 may de-register from PS services with the first network 408 through the second RAT in operation 438. In this manner, FIGS. 4A-4B illustrate dynamic activation of the signaling overhead for PS services through the second RAT. If no applications are utilizing on-demand PS services, the PS signaling is deactivated.

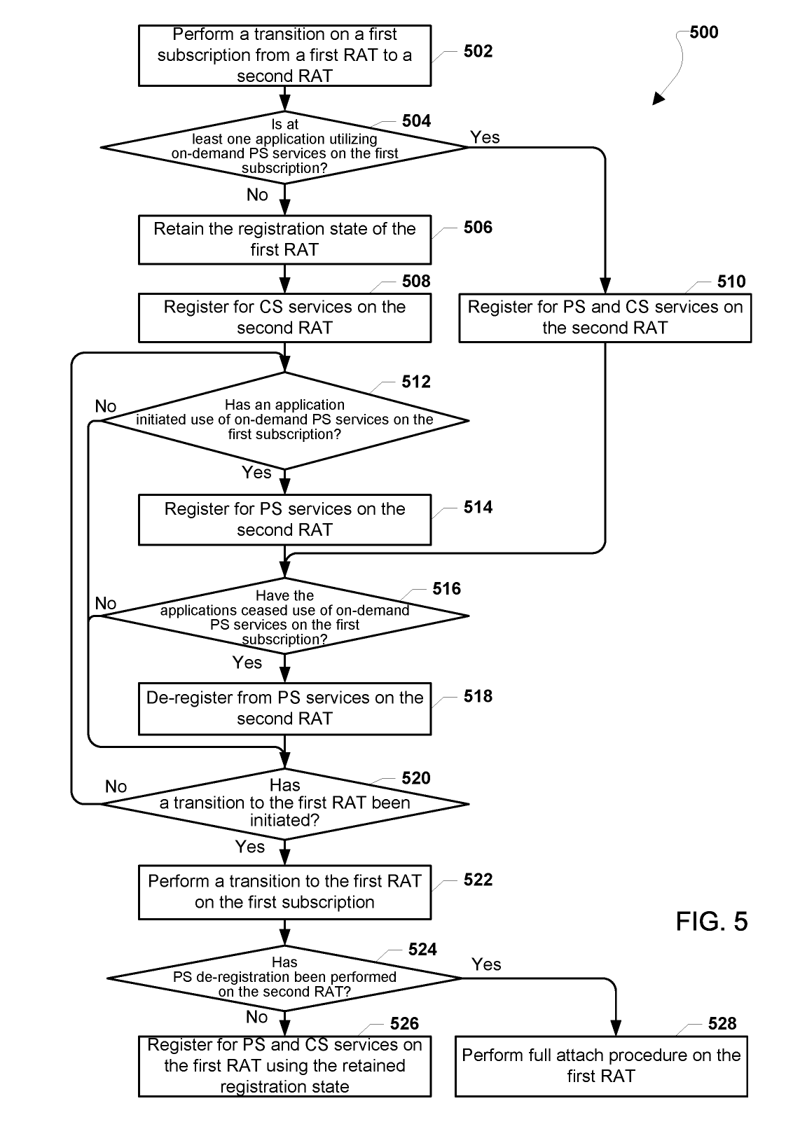

FIG. 5 illustrates a method 500 for managing PS states on a mobile communication device according to various examples. The method 500 may be implemented with a processor (e.g., the general processor 206, the baseband modem processor 216, a separate controller, and/or the like) of a mobile communication device (such as the mobile communication devices 110, 120) that supports a first subscription and a second subscription. The second subscription may be the DDS subscription and the first subscription may be the non-DDS subscription. The first subscription may communicate with a first network through two or more RATs. A first RAT may be an LTE RAT or another newer generation RAT (e.g., 4G or 5G) while a second RAT may be a GSM or WCDMA RAT or another legacy RAT (e.g., 2G or 3G). The second subscription may communicate with a second network through one or more RATs (e.g., LTE).

In block 502, the processor may perform a transition on the first subscription from the first RAT to the second RAT. The first subscription may be utilized by one or more applications to communicate with the first network. The inter-RAT transition may be a RAT reselection initiated by the mobile communication device or a RAT redirection initiated by the first network in order to acquire better service or when handing off to neighboring cells.

In determination block 504, the processor may determine whether there is at least one application utilizing on-demand PS services on the first subscription. For example, the processor may check whether there are any applications connected to non-IMS PDNs or otherwise utilizing on-demand PS services on the first subscription to communicate with the first network.

In response to determining that there is at least one application utilizing on-demand PS services on the first subscription (i.e., determination block 504=“Yes”), the processor may register for PS and CS services with the first network on the second RAT in block 510. For example, the processor may perform a RAU on the first subscription to notify the first network of the location of the mobile communication device in order to receive PS and CS services.

In response to determining that no applications are utilizing PS services on the first subscription (i.e., determination block 504=“No”), the processor may retain the registration state information of the first RAT in block 506. The registration state information may include the PDN context and the EMM registration state of the first RAT. For example, the processor may cache the PDN context and the EMM registration state of the first RAT in local memory so that the information may be reused if the first subscription performs an inter-RAT transition back to the first RAT.

In block 508, the processor may register for CS services (but not PS services) with the first network on the second RAT. For example, the processor may perform a LAU on the first subscription to notify the first network of the location of the mobile communication device in order to receive CS services.

In determination block 512, the processor may determine whether an application has initiated use of on-demand PS services on the first subscription. Even though no applications may have utilized on-demand PS services when the inter-RAT transition occurred, an application may later start using on-demand PS services. For example, an application may initiate a connection with a non-IMS PDN.

In response to determining that an application has initiated use of on-demand PS services on the first subscription (i.e., determination block 512=“Yes”), the processor may register for PS services with the first network on the second RAT in block 514. For example, the processor may perform a PDP establishment procedure with the first network. This enables PS services to be dynamically activated on the second RAT when there is demand for PS services from one or more applications.

After registering for PS and CS services if an application is utilizing on-demand PS services when the inter-RAT transition occurred in block 510, or after registering for PS services if an application initiates use of on-demand PS services after the inter-RAT transition occurs in block 514, the processor may determine whether the application(s) have ceased use of on-demand PS services on the first subscription in determination block 516. For example, the applications that are using on-demand PS services may release the PDP to stop using PS services.

In response to determining that the application(s) have ceased use of on-demand PS services on the first subscription (i.e., determination block 516=“Yes”), the processor may de-register from PS services with the first network on the second RAT in block 518. This enables PS services to be dynamically deactivated on the second RAT when there is no longer any demand for PS services from any applications.

In response to determining that the application(s) have not ceased use of on-demand PS services on the first subscription (i.e., determination block 516=“No”), or after de-registering from PS services with the first network on the second RAT in block 518, the processor may determine whether a transition from the second RAT to the first RAT has been initiated in determination block 520. For example, the mobile communication device may initiate a RAT reselection back to the first RAT, or the first network may initiate a RAT redirection back to the first RAT.

In response to determining that a transition from the second RAT to the first RAT has not been initiated (i.e., determination block 520=“No”), the processor may continue monitoring for whether any applications have initiated use of on-demand PS services on the first subscription in determination block 512. In other words, if the first subscription remains on the second RAT, the processor may continue determining whether PS services on the second RAT should be dynamically enabled or disabled.

In response to determining that a transition from the second RAT to the first RAT has been initiated (i.e., determination block 520=“Yes”), the processor may perform a transition to the first RAT on the first subscription in block 522.

In determination block 524, the processor may determining whether PS de-registration has been performed on the second RAT.

In response to determining that de-registration has not been performed on the second RAT (i.e., determination block 524=“No”), the processor may register for PS and CS services with the first network on the first RAT using the retained registration state for the first RAT in block 526. For example, the first subscription may perform a TAU with the retained PDN context and EMM registration state of the first RAT to register with the first network. This process may be quicker than performing a full attach procedure with the first network.

In response to determining that de-registration has been performed on the second RAT (i.e., determination block 524=“Yes”), the processor may perform a full attach procedure on the first RAT in block 528.

Thus, the operations in the method 500 provides a way to save battery power on a mobile communication device by dynamically enabling and disabling PS services based on application demand.

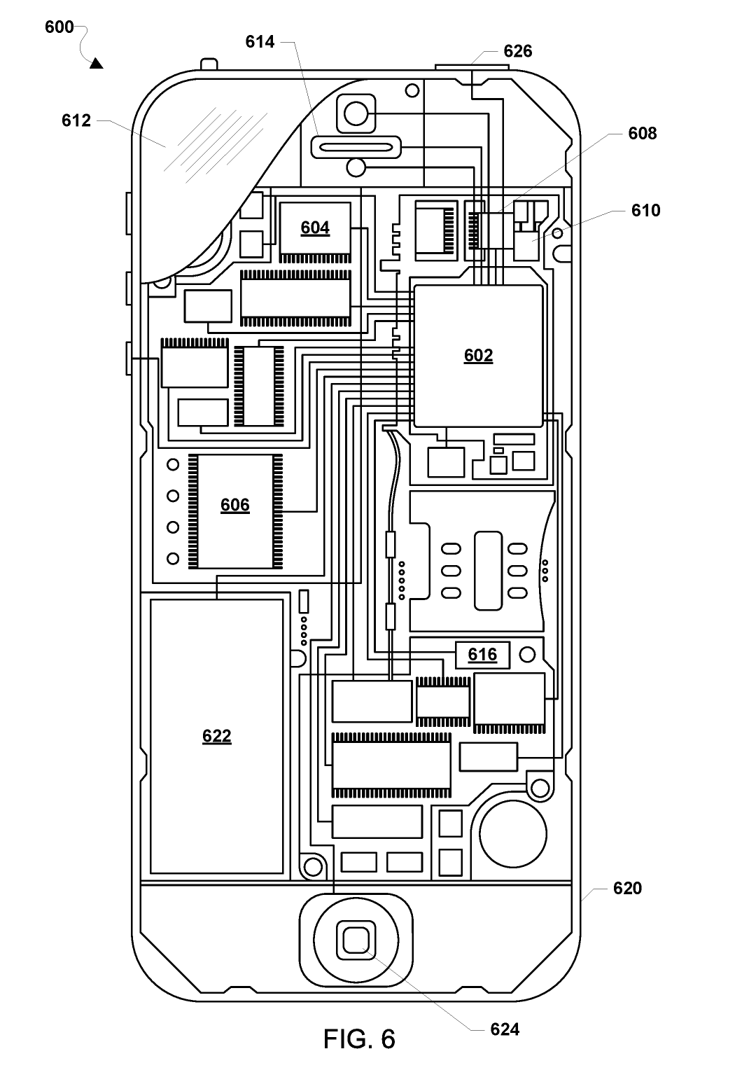

Various examples may be implemented in any of a variety of communication devices, an example of which (e.g., multi-SIM mobile communication device 600) is illustrated in FIG. 6. The multi-SIM mobile communication device 600 may be similar to the mobile communication devices 110, 120, 200, 402 as described. As such, the multi-SIM mobile communication device 600 may implement the method 500 according to various examples.

The multi-SIM mobile communication device 600 may include a processor 602 coupled to a touchscreen controller 604 and an internal memory 606. The processor 602 may be one or more multi-core integrated circuits designated for general or specific processing tasks. The internal memory 606 may be volatile or non-volatile memory, and may also be secure and/or encrypted memory, or unsecure and/or unencrypted memory, or any combination thereof. The touchscreen controller 604 and the processor 602 may also be coupled to a touchscreen panel 612, such as a resistive-sensing touchscreen, capacitive-sensing touchscreen, infrared sensing touchscreen, etc. Additionally, the display of the multi-SIM mobile communication device 600 need not have touch screen capability.

The multi-SIM mobile communication device 600 may have one or more cellular network transceivers 608 coupled to the processor 602 and to one or more antennas 610 and configured for sending and receiving cellular communications. The one or more transceivers 608 and the one or more antennas 610 may be used with the herein-mentioned circuitry to implement various example methods. The multi-SIM mobile communication device 600 may include one or more SIM cards 616 coupled to the one or more transceivers 608 and/or the processor 602 and may be configured as described herein.

The multi-SIM mobile communication device 600 may also include speakers 614 for providing audio outputs. The multi-SIM mobile communication device 600 may also include a housing 620, constructed of a plastic, metal, or a combination of materials, for containing all or some of the components discussed herein. The multi-SIM mobile communication device 600 may include a power source 622 coupled to the processor 602, such as a disposable or rechargeable battery. The rechargeable battery may also be coupled to the peripheral device connection port to receive a charging current from a source external to the multi-SIM mobile communication device 600. The multi-SIM mobile communication device 600 may also include a physical button 624 for receiving user inputs. The multi-SIM mobile communication device 600 may also include a power button 626 for turning the multi-SIM mobile communication device 600 on and off.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example.

The foregoing method descriptions and the process flow diagrams are provided merely as illustrative examples and are not intended to require or imply that the operations of various examples must be performed in the order presented. As will be appreciated by one of skill in the art the order of operations in the foregoing examples may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the examples disclosed herein may be implemented as electronic hardware, computer software, or combinations of both. To clearly illustrate this interchangeability of hardware and software, various illustrative components, blocks, modules, circuits, and operations have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present examples.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configurations. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc in which disks usually reproduce data magnetically, while discs reproduce data optically with lasers. Combinations of the storage media are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed examples is provided to enable any person skilled in the art to make or use the present examples. Various modifications to these examples will be readily apparent to those skilled in the art, and the generic principles defined herein may be applied to some examples without departing from the spirit or scope of the written description. Thus, the present disclosure is not intended to be limited to the examples shown herein but is to be accorded the widest scope consistent with the following claims and the principles and novel features disclosed herein.

What is claimed is:

1. A method for managing packet switched (PS) states on a mobile communication device, comprising:
performing, on a first subscription on the mobile communication device, a transition from a first radio access technology (RAT) to a second RAT;
determining whether at least one application on the mobile communication device is utilizing on-demand PS services on the first subscription; and
registering for circuit switched (CS) services but not PS services on the second RAT in response to determining that no applications on the mobile communication device is utilizing on-demand PS services on the first subscription.

2. The method of claim 1, wherein registering for CS services on the second RAT comprises performing a location area update on the first subscription.

3. The method of claim 1, further comprising:
registering for PS services and CS services on the second RAT in response to determining that at least one application on the mobile communication device is utilizing on-demand PS services on the first subscription.

4. The method of claim 3, wherein registering for PS and CS services on the second RAT comprises performing a routing area update on the first subscription.

5. The method of claim 4, further comprising:
determining whether all applications cease utilizing PS services; and
de-registering from PS services on the second RAT in response to determining that all applications cease utilizing PS services.

6. The method of claim 1, further comprising:
determining whether an application initiates use of PS services after registering for CS services on the second RAT; and
registering for PS services on the second RAT in response to determining that an application initiates use of PS services after registering for CS services on the second RAT.

7. The method of claim 6, further comprising:
determining whether the application ceases utilizing PS services; and
de-registering from PS services on the second RAT in response to determining that the application ceases utilizing PS services.

8. The method of claim 1, further comprising retaining a registration state of the first RAT, wherein the registration state of the first RAT comprises a packet data network context and an evolved packet system mobility management registered state of the first RAT.

9. The method of claim 8, further comprising:
performing a transition from the second RAT to the first RAT; and
registering for PS and CS services on the first RAT using the retained registration state of the first RAT.

10. The method of claim 9, further comprising:
determining whether PS de-registration has been performed on the second RAT; and
performing a full attach procedure on the first RAT in response to determining that PS de-registration has been performed on the second RAT,
wherein registering for PS and CS services on the first RAT using the retained registration state of the first RAT is performed in response to determining that PS de-registration has not been performed on the second RAT.

11. The method of claim 1, wherein the first RAT is a long term evolution (LTE) RAT.

12. The method of claim 1, wherein the second RAT is a Wideband Code Division Multiple Access (WCDMA) RAT or a Global System for Mobile Communications (GSM) RAT.

13. The method of claim 1, wherein the first subscription is a non-designated data subscription.

14. The method of claim 1, wherein the on-demand PS services comprises a non-Internet Protocol (IP) Multimedia System (IMS) packet data network (PDN) service.

15. A mobile communication device, comprising:
a memory;
a radio frequency (RF) resource; and
a processor coupled to the memory and the RF resource, configured to connect to a first subscriber identity module (SIM) associated with a first subscription, and configured to:
perform, on the first subscription, a transition from a first radio access technology (RAT) to a second RAT;
determine whether at least one application on the mobile communication device is utilizing on-demand packet switched (PS) services on the first subscription; and
register for circuit switched (CS) services but not PS services on the second RAT in response to determining that no applications on the mobile communication device is utilizing on-demand PS services on the first subscription.

16. The mobile communication device of claim 15, wherein the processor is further configured to register for CS services on the second RAT by performing a location area update on the first subscription.

17. The mobile communication device of claim 15, wherein the processor is further configured to:
register for PS services and CS services on the second RAT in response to determining that at least one application on the mobile communication device is utilizing on-demand PS services on the first subscription.

18. The mobile communication device of claim 17, wherein the processor is further configured to register for PS and CS services on the second RAT by performing a routing area update on the first subscription.

19. The mobile communication device of claim 18, wherein the processor is further configured to:
determine whether all applications cease utilizing PS services; and
de-register from on-demand PS services on the second RAT in response to determining that all applications cease utilizing PS services.

20. The mobile communication device of claim 15, wherein the processor is further configured to:
determine whether an application initiates use of PS services after registering for CS services on the second RAT; and
register for PS services on the second RAT in response to determining that an application initiates use of PS services after registering for CS services on the second RAT.

21. The mobile communication device of claim 20, wherein the processor is further configured to:
determine whether the application ceases utilizing PS services; and
de-register from PS services on the second RAT in response to determining that the application ceases utilizing PS services.

22. The mobile communication device of claim 15, wherein the processor is further configured to:
retain a registration state of the first RAT, wherein the registration state of the first RAT comprises a packet data network context and an evolved packet system mobility management registered state of the first RAT.

23. The mobile communication device of claim 22, wherein the processor is further configured to:
perform a transition from the second RAT to the first RAT; and
register for PS and CS services on the first RAT using the retained registration state of the first RAT.

24. The mobile communication device of claim 23, wherein the processor is further configured to:
determine whether PS de-registration has been performed on the second RAT; and
perform a full attach procedure on the first RAT in response to determining that PS de-registration has been performed on the second RAT,
wherein the processor is further configured to register for PS and CS services on the first RAT using the retained registration state of the first RAT in response to determining that PS de-registration has not been performed on the second RAT.

25. The mobile communication device of claim 15, wherein the first RAT is a long term evolution (LTE) RAT.

26. The mobile communication device of claim 15, wherein the second RAT is a Wideband Code Division Multiple Access (WCDMA) RAT or a Global System for Mobile Communications (GSM) RAT.

27. The mobile communication device of claim 15, wherein the first subscription is a non-designated data subscription.

28. The mobile communication device of claim 15, wherein the on-demand PS services comprises a non-Internet Protocol (IP) Multimedia System (IMS) packet data network (PDN) service.

29. A non-transitory computer readable storage medium having stored thereon processor-executable software instructions configured to cause a processor of a mobile communication device to perform operations comprising:
performing, on a first subscription on the mobile communication device, a transition from a first radio access technology (RAT) to a second RAT;
determining whether at least one application on the mobile communication device is utilizing on-demand packet switched (PS) services on the first subscription; and
registering for circuit switched (CS) services but not PS services on the second RAT in response to determining that no applications on the mobile communication device is utilizing on-demand PS services on the first subscription.

30. A mobile communication device, comprising:
means for performing, on a first subscription on the mobile communication device, a transition from a first radio access technology (RAT) to a second RAT;
means for determining whether at least one application on the mobile communication device is utilizing on-demand packet switched (PS) services on the first subscription; and
means for registering for circuit switched (CS) services but not PS services on the second RAT in response to determining that no applications on the mobile communication device is utilizing on-demand PS services on the first subscription.
